(19) United States
(12) Patent Application Publication
(10) Pub. No.: US 2004/0175986 A1
(43) Pub. Date: Sep. 9, 2004

(54) LAND GRID ARRAY CONNECTOR ASSEMBLY WITH MOUNTING BASE

(75) Inventors: Fang-Jwu Liao, Tu-Chen (TW); Ming-Lun Szu, Tu-Chen (TW)

Correspondence Address: WEI TE CHUNG, FOXCONN INTERNATIONAL, INC., 1650 MEMOREX DRIVE, SANTA CLARA, CA, 95050, US

(73) Assignee: HON HAI PRECISION IND. CO., LTD., Tu-Chen (TW)

(21) Appl. No.: 10/605,799

(22) Filed: Oct. 28, 2003

(30) Foreign Application Priority Data
Mar. 5, 2003 (TW) 92203293

(51) Int. Cl. H01R 12/00

(52) U.S. Cl. 439/526

(57) ABSTRACT

An electrical connector assembly (1) for electrically connecting an electronic package (5) with a circuit substrate. The connector assembly includes an electrical connector (2) and a mounting base (3). The connector defines a pair of spring arms (241) in two adjacent sidewalls (24). The mounting base defines a pair of guiding blocks (321) corresponding to the spring arms. When the connector is put in the mounting base, the spring arms slidably engage with the blocks, and the spring arms are pushed to bent outwardly. Thus the electronic package can be attached on the connector with zero insertion force. Then the connector is removed from the mounting base. The spring arms disengage from the blocks, and resiliently rebound toward their normal positions thereby secure the electronic package in the connector.

### BACKGROUND OF INVENTION

1. Field of the Invention

The present invention relates to an electrical connector for electrically connecting an electronic package such as a central processing unit (CPU) with a circuit substrate such as a printed circuit board (PCB), and particularly to a land grid array connector having a mounting base to help attach the CPU on the connector with zero insertion force.

2. Description of Related Art

An integrated circuit (IC) package having leads arranged in a land grid array (LGA) is known as an LGA package. LGA packages have relatively low height, which saves valuable space in electronic assemblies.

Connectors for removably mounting an LGA package on a PCB are known as LGA connectors. An LGA connector combined with ball grid array (BGA) technology typically comprises a thin and substantially flat insulative housing which is positioned between the LGA package and the PCB. The housing defines an array of passageways receiving electrical terminals therein. The terminals correspond with the array of leads of the LGA package. Each terminal has a pair of opposite free ends that project beyond opposite top and bottom external surfaces of the housing. Prior to mounting of the LGA package on the PCB, the free ends of the terminals are spaced apart a predetermined distance. Then, the LGA package is secured on the connector. The free ends of the terminals are respectively engaged with corresponding contact pads on a bottom surface of the LGA package, and soldered to contact pads on a mounting surface of the PCB.

This kind of conventional LGA connector is disclosed in U.S. Pat. Nos. 6,146,152, 6,186,797, 6,164,978, 6,203,331 and 6.179,624.

Referring to FIG. 14, a conventional LGA connector 6 disclosed in U.S. Pat. No. 6,146,152 is for electrically connecting a CPU 7 with a PCB (not shown). The connector 6 comprises an insulative housing 64 with a plurality of conductive terminals 8 received therein. The housing 64 comprises four raised sidewalls 61, and the sidewalls 61 cooperatively define a shallow recess 63 therebetween. A plurality of passageways 60 is defined in the housing 64 under the recess 63. Each passageway 60 receives a corresponding terminal 8 therein.

A first through slot 610 is defined in the first raised sidewall 61. A first spring arm 611 is formed in the first raised sidewall 61, and is capable of resilient deformation in the first through slot 610. Two second through slots 620 are defined in the second raised sidewall 61 adjacent the first raised sidewall 61. Two second spring arms 612 are formed in the second raised sidewalls 61, and are capable of resilient deformation in the corresponding second through slots 620. The first spring arm 611 and the second spring arms 612 each have a chamfer surface 611A, 612A respectively formed on a free end thereof, the chamfer surfaces 611A, 612A cooperatively guiding insertion of the CPU 7 into the recess 63.

Firstly, the CPU 7 is put in the recess 63 of the housing 64, and engages with the chamfer surfaces 611A, 612A. Then the CPU 7 is pushed downwardly, so that the CPU 7 pushes the spring arms 611, 612 to move toward the raised sidewalls 61. When the CPU 7 reaches distal ends of the chamfer surfaces 611A, 612A, the CPU 7 disengages from the spring arms 611, 612 and moves steadily downwardly until it reaches an upper surface of the housing 64 under the recess 63. At this position, the spring arms 611, 612 resiliently rebound to their normal positions and secure the CPU 7 in the recess 63.

The CPU 7 needs to exert a relatively large downward force to perform the above-described operation. Thus when the CPU 7 moves downwardly along the chamfer surfaces 611A, 612A, frictional forces created between the chamfer surfaces 611A, 612A and the CPU 7 are relatively large. As a result, the chamfer surfaces 611A, 612A may shed some fragments such as plastic particles. When these foreign fragments fall into the recess 63, they may fall on some terminals 8. In such case, stable electrical connection between the CPU 7 and the terminals 8 may be impaired or even lost altogether.

In view of the above, a new LGA connector assembly that overcomes the above-mentioned disadvantages is desired.

### SUMMARY OF INVENTION

Accordingly, an object of the present invention is to provide an electrical connector assembly such as a land grid array (LGA) connector assembly for electrically connecting an electronic package such as an LGA central processing unit (CPU) with a circuit substrate such as a printed circuit board (PCB), whereby the LGA connector assembly includes an extra component to help attach the CPU on the connector with zero insertion force.

To achieve the above-mentioned object, an LGA connector assembly in accordance with the present invention is for electrically connecting an LGA CPU with a PCB. The LGA connector assembly comprises an electrical connector and a mounting base. The connector defines a pair of spring arms in two adjacent sidewalls. The mounting base defines a pair of trapeziform guiding blocks corresponding to the spring arms of the connector. When the connector is put in the mounting base, the spring arms slidably engage with the blocks. As the connector move downwardly, the spring arms are pushed by the guiding blocks to bend toward the corresponding sidewalls. Thus the CPU can be attached in the connector with zero insertion force. Then the connector is removed from the mounting base, the spring arms disengage from the blocks and resiliently rebound toward their normal positions thereby securing the CPU in the connector.

Alternatively, the LGA connector assembly comprises an electrical connector, a mounting base and an auxiliary tray. The connector defines a pair of spring arms at two adjacent sidewalls. The mounting base defines a pair of trapeziform guiding blocks corresponding to the spring arms. A plurality of coil springs is received in the mounting base. The auxiliary tray defines a pair of mating slots respectively corresponding to the spring arms of the connector. The auxiliary tray is put on the mounting base, with the coil springs of the mounting base engaging with a bottom of the auxiliary tray. The guiding blocks of the mounting base pass through the mating slots of the auxiliary tray. When the connector is put in the auxiliary tray, the spring arms of the connector slidably engage with the blocks of the mounting base. As the connector moves downwardly, the spring arms are pushed by the guiding blocks to bend toward the corresponding sidewalls. Thus the electronic package can be attached in the connector with zero insertion force. Then the insertion force is released, and the coil springs resiliently return to their normal positions. Thus, the auxiliary tray is pushed upwardly, and the spring arms disengage from the blocks. The spring arms resiliently rebound toward their normal positions and thereby secure the electronic package on the connector.

Other objects, advantages and novel features of the invention will become more apparent from the following detailed description when taken in conjunction with the accompanying drawings, in which:

### BRIEF DESCRIPTION OF DRAWINGS

FIG. 1 is a simplified, exploded, isometric view of an LGA connector assembly in accordance with a preferred embodiment of the present invention, also showing a CPU ready to be attached on the connector assembly;

FIG. 2 is an enlarged, assembled view of the connector assembly of FIG. 1;

FIG. 3 is similar to FIG. 2, but showing the CPU attached on the connector assembly;

FIG. 4A is an enlarged, side elevation of one of two spring arms of an LGA connector and a corresponding actuating block of a mounting base of the connector assembly of FIG. 2, showing the spring arm not contacting the actuating block;

FIG. 4B is similar to FIG. 4A, but showing the spring arm contacting an actuating surface of the actuating block;

FIG. 4C is similar to FIG. 4B, but showing the spring arm slid to a lowest position in contact with the actuating surface of the actuating block;

FIG. 5 is similar to FIG. 3, but showing the connector removed from the mounting base, and the CPU secured in the connector by the spring arms;

FIG. 6 is a simplified, exploded, isometric view of an LGA connector assembly in accordance with an alternative embodiment of the present invention, also showing a CPU ready to be attached on the connector assembly;

FIG. 7 is an enlarged view of a mounting base of the connector assembly of FIG. 6;

FIG. 8 is an enlarged view of an auxiliary tray of the connector assembly of FIG. 6;

FIG. 9 is similar to FIG. 8, but showing the auxiliary tray inverted;

FIG. 10 is an enlarged, assembled view of the mounting base and the auxiliary tray of FIG. 6;

FIG. 11 is an enlarged, assembled view of the connector assembly of FIG. 6;

FIG. 12 is similar to FIG. 11, but showing the CPU attached on the connector assembly but not secured by spring arms of an LGA connector of the connector assembly;

FIG. 13 is similar to FIG. 12, but showing the CPU attached on the connector assembly and secured by the spring arms; and

FIG. 14 is an isometric view of a conventional LGA connector, also showing a CPU ready to be attached on the connector.

### DETAILED DESCRIPTION

Reference will now be made to the drawings to describe the present invention in detail.

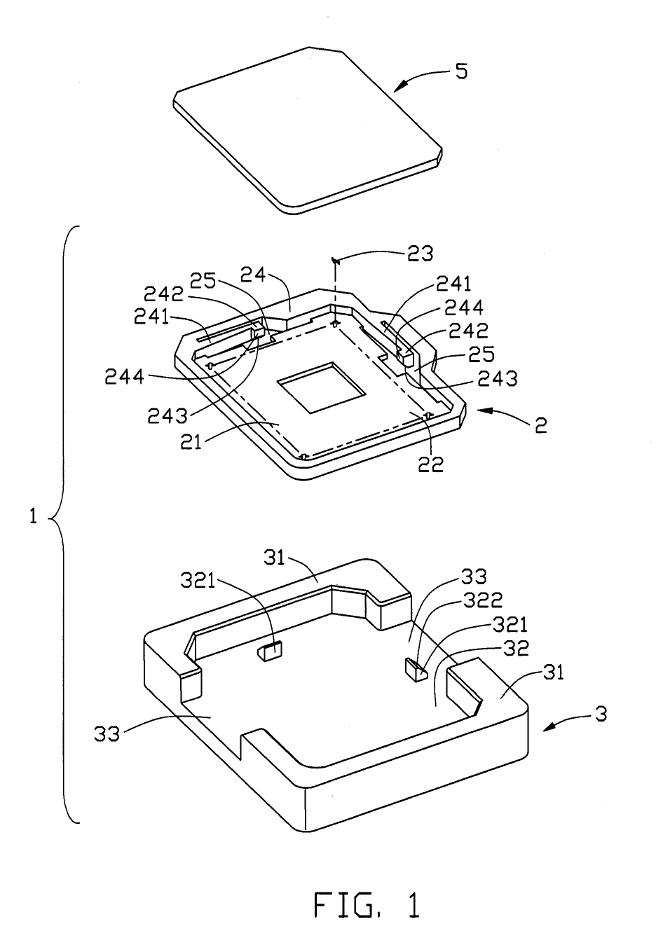

Referring to FIG. 1, an electrical connector assembly 1 in accordance with the preferred embodiment of the present invention is for electrically connecting an electronic package such as a central processing unit (CPU) 5 with a circuit substrate such as a printed circuit board (PCB) (not shown). The connector assembly 1 comprises an electrical connector 2 and a mounting base 3.

The connector 2 is generally rectangular, and comprises four raised sidewalls 24. The sidewalls 24 cooperatively define a shallow recess 21 therebetween. The connector 2 defines a conductive region 22 under the recess 21. A plurality of conductive terminals 23 is received in the conductive region 22. A pair of spring arms 241 is formed in two adjacent sidewalls 24. A pair of through slots 25 is defined on the conductive region 22, corresponding to the spring arms 241 respectively. Each spring arm 241 forms a retaining portion 242 at a free distal end. The retaining portion 242 comprises an inner vertical retaining surface 244 parallel to the corresponding sidewall 24. The retaining portion 242 further comprises a slantwise acting surface 243 below and adjoining the retaining surface 244.

The mounting base 3 is substantially rectangular, and comprises a pair of opposite raised “U”-shaped sidewalls 31. The sidewalls 31 cooperatively define a receiving space 32 therebetween. A pair of cutouts 33 is defined between respective opposing ends of the sidewalls 31. A pair of trapeziform guiding blocks 321 is formed on the mounting base 3 at the receiving space 32, corresponding to the spring arms 241 of the connector 2. One guiding block 321 is near one of the cutouts 33, and the other guiding block 321 is near one of the sidewalls 31. Each guiding block 321 comprises a slantwise guiding surface 322 generally facing a periphery of the connector 2.

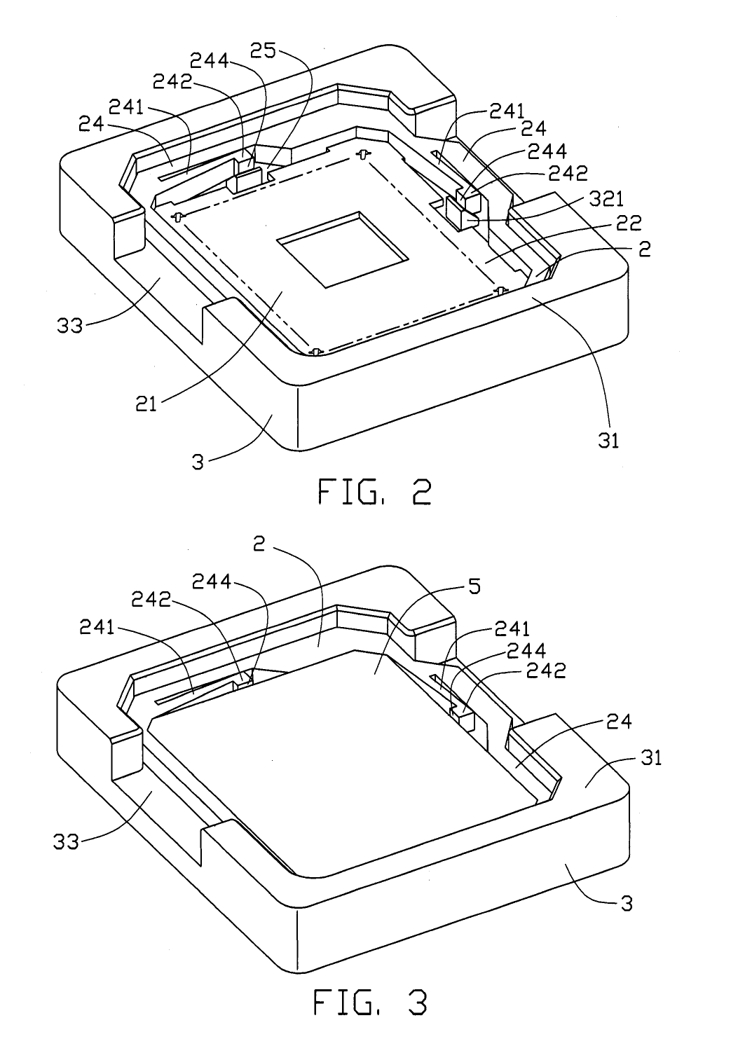

FIG. 2 shows the connector 2 inserted in the mounting base 3. FIGS. 4A, 4B and 4C show successive stages of mating of the retaining portion 242 of one spring arm 241 of the connector 2 and the corresponding guiding block 321 of the mounting base 3 during the process of insertion of the connector 2 into the mounting base 3. Firstly, the spring arms 241 of the connector 2 are aligned with the guiding blocks 321 of the mounting base 3 (see FIG. 4A). Then, the connector 2 is inserted in the receiving space 32 of the mounting base 3 by a downward insertion force. The guiding blocks 321 pass through the through slots 25 and mate with the retaining portions 242 of the connector 2. The guiding surfaces 322 of the guiding blocks 321 slidably engage with the acting surfaces 243 of the spring arms 241 (see FIG. 4B). As the connector 2 moves downwardly, the acting surfaces 243 slide along the guiding surfaces 322 until the connector 2 is fully received in the receiving space 32 (see FIG. 4C). Thereafter, the insertion force is maintained in order to keep the connector 2 in this position.

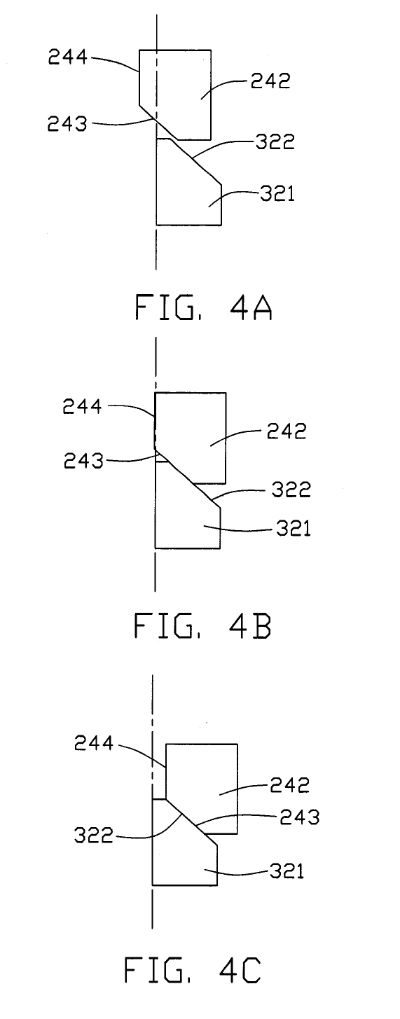

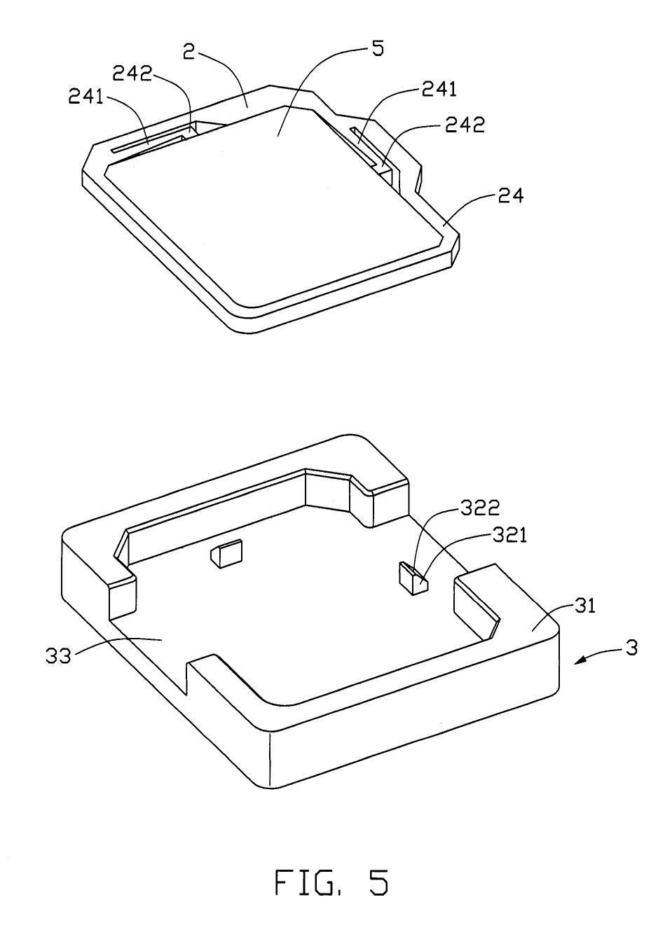

As the acting surfaces 243 slide along the guiding surfaces 322, the spring arms 241 are pushed by the guiding blocks 321 to bend toward the corresponding sidewalls 24. When the connector 2 is fully received in the receiving space 32, a distance between each retaining portion 242 and a corresponding opposite sidewall 24 is greater than a corresponding width of the CPU 5. Thus the CPU 5 can be attached on the connector 2 with zero insertion force (see FIG. 3).

FIG. 5 shows the connector 2 removed from the mounting base 3, with the CPU 5 being resiliently secured in the recess 21 of the connector 2 by the spring arms 241. To attain this position, the insertion force applied on the connector 2 is released, and the connector 2 is pulled upwardly. As the connector 2 is pulled up from the mounting base 3, the retaining portions 242 slidingly disengage from the guiding surfaces 322 of the guiding blocks 321. The spring arms 241 thus resiliently rebound away from the corresponding sidewalls 24 toward their normal positions. The retaining surfaces 244 of the spring arms 241 resiliently engage with corresponding sides of the CPU 5, and thereby securely retain the CPU 5 in the recess 21 of the connector 2.

Because the CPU 5 is inserted in the recess 21 of the connector 2 with zero insertion force, the CPU 5 does not interfere with the spring arms 241 of the connector 2. That is, no frictional force occurs between the spring arms 241 and the CPU 5, and the spring arms 241 remain intact and undamaged. In particular, the spring arms 241 do not shed any fragments such as plastic particles. The recess 21 is kept clean of foreign fragments, and the terminals 23 remain intact and unimpeded. Thus, stable and reliable electrical connection between the CPU 5 and the terminals 23 of the connector 2 is provided.

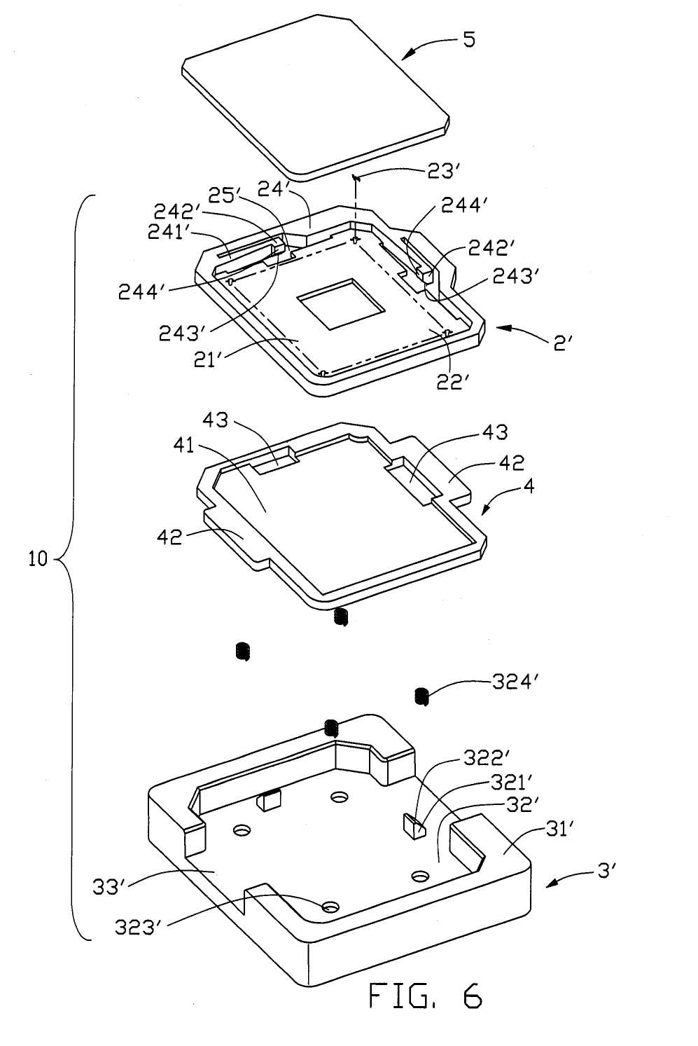

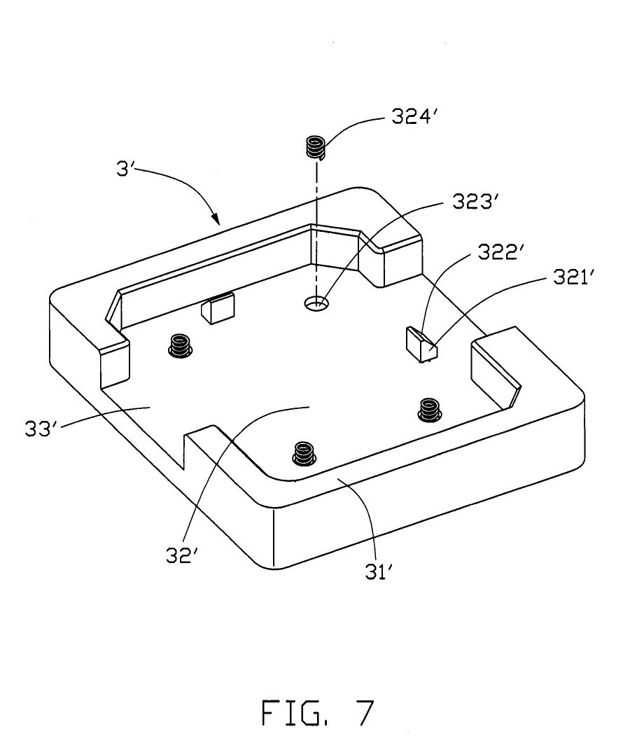

FIG. 6 shows an electrical connector assembly 10 in accordance with the alternative embodiment of the present invention. The connector assembly 10 comprises a connector 2′, a mounting base 3′ and an auxiliary tray 4. A structure of the connector 2′ is the same as that of the connector 2 of the preferred embodiment. FIG. 7 shows an enlarged view of the mounting base 3′. A structure of the mounting base 3′ is similar to that of the mounting base 3 of the preferred embodiment, except that the mounting base 3′ further defines four blind receiving holes 323′ therein below a receiving space 32′ thereof. Each receiving hole 323′ receives an elastic member therein. In the alternative embodiment, each elastic member is a spring 324′.

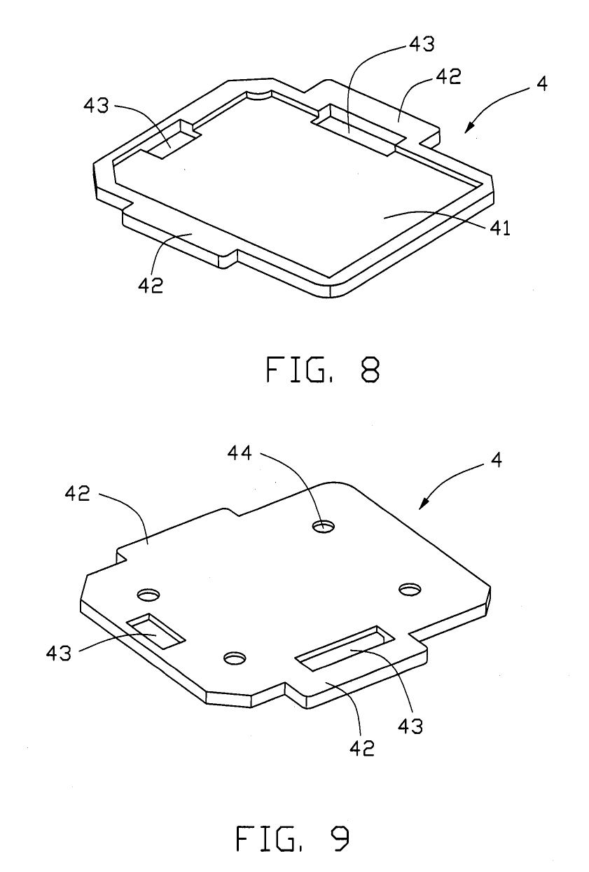

FIG. 8 is an enlarged view of the auxiliary tray 4. The auxiliary tray 4 is substantially rectangular, and defines a shallow positioning space 41 therein. The auxiliary tray 4 forms a pair of positioning arms 42, corresponding to the cutouts 33′ of the mounting base 3′. A pair of through acting slots 43 is defined in the auxiliary tray 4 below and in communication with the positioning space 41, corresponding to the guiding blocks 321′ of the mounting base 3′. FIG. 9 is an enlarged, inverted view of the auxiliary tray 4. Four blind retaining holes 44 are defined in a bottom of the auxiliary tray 4, corresponding to the springs 324′.

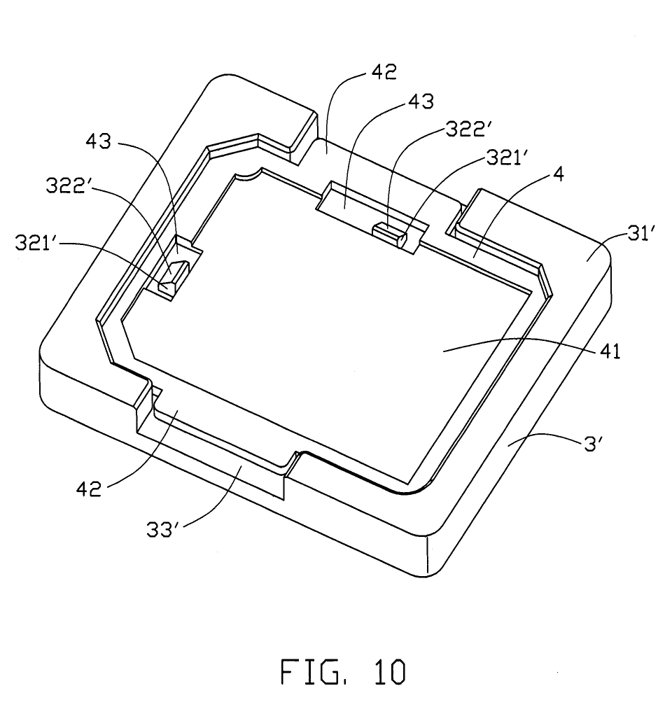

FIG. 10 is an enlarged, assembled view of the auxiliary tray 4 and the mounting base 3′. Firstly, the springs 324′ are stood in the receiving holes 323′ of the mounting base 3′. The auxiliary tray 4 is put in the receiving space 32′ of the mounting base 3′, with the positioning arms 42 being received in the corresponding cutouts 33′. The guiding blocks 321′ of the mounting base 3′ pass through the corresponding acting slots 43 of the auxiliary tray 4. Top ends of the springs 324′ are received in the corresponding retaining holes 44 of the auxiliary tray 4. Thus, a gap (not shown) is created between the auxiliary tray 4 and the mounting base 3′.

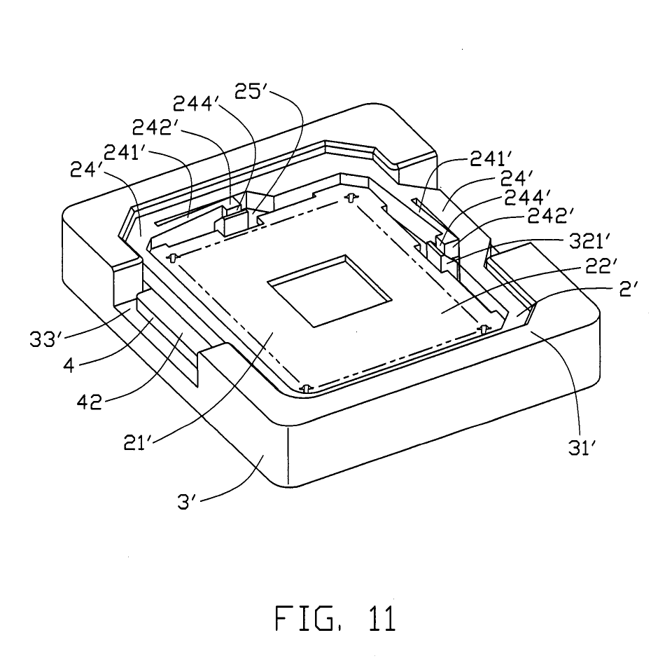

Then the connector 2′ is placed in the positioning space 41 of the auxiliary tray 4, with sidewalls 24′ of the connector 2′ interferingly fitting within sidewalls of the auxiliary tray 4 (see FIG. 11). Thus, the connector 2′ is received in the positioning space 41 of the auxiliary tray 4, but without touching any part of the auxiliary tray 4 that lies below the positioning space 41. That is, the connector 2′ is engaged in a “suspended” position in the positioning space 41. Guiding blocks 321′ of the mounting base 3′ pass through through slots 25′ and engage with spring arms 241′ of the connector 2′. Guiding surfaces 322′ of the guiding blocks 321′ slidably engage with acting surfaces 243′ of retention portions 242′ of the spring arms 241′.

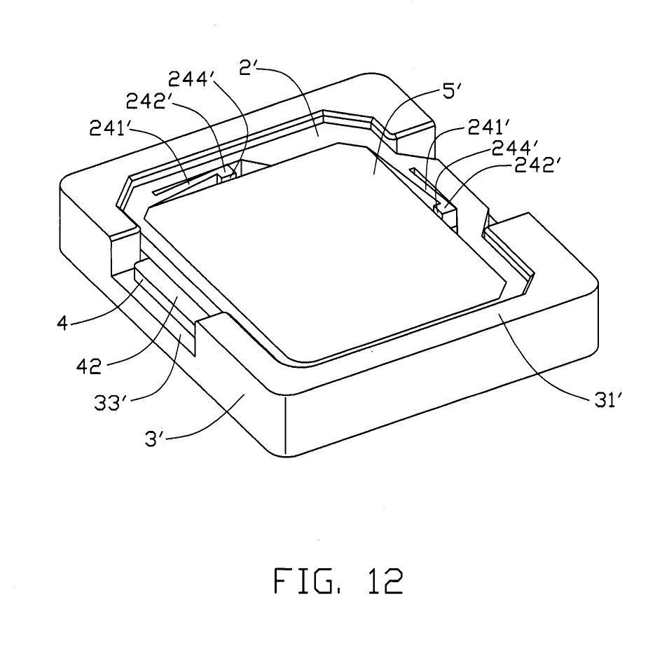

Then, the connector 2′ is pushed downwardly, with the acting surfaces 243′ of the spring arms 241′ sliding along the guiding surfaces 322′ of the guiding blocks 321′. Thus, the spring arms 241′ are pushed by the guiding blocks 321′ to bend toward the corresponding sidewalls 24′, and the auxiliary tray 4 moves down toward the mounting base 3′. The gap between the auxiliary tray 4 and the mounting base 3′ becomes progressively smaller. When the connector 2′ is fully received in the positioning space 41, a distance between a retaining portion 242′ of each spring arm 241′ and a corresponding opposite sidewall 24′ is greater than a corresponding width of the CPU 5. Thereafter, the downward pushing force is maintained in order to keep the connector 2′ in this position. The CPU 5 can then be attached on the connector 2′ with zero insertion force (see FIG. 12).

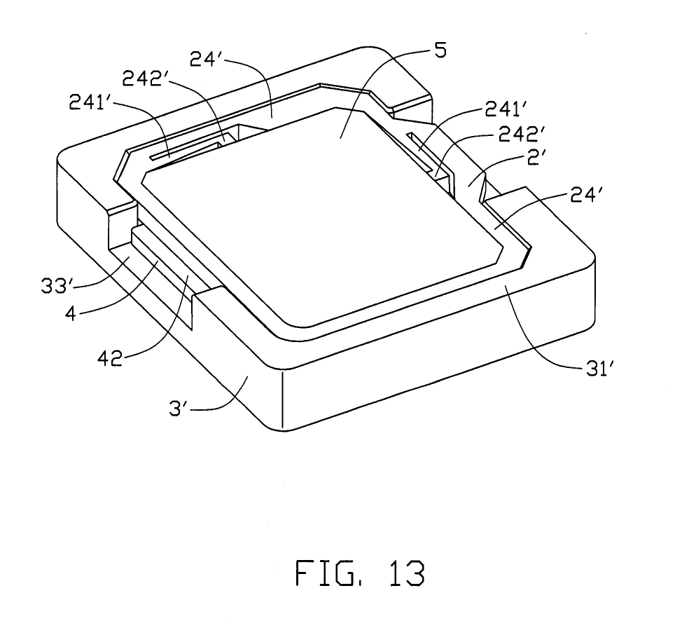

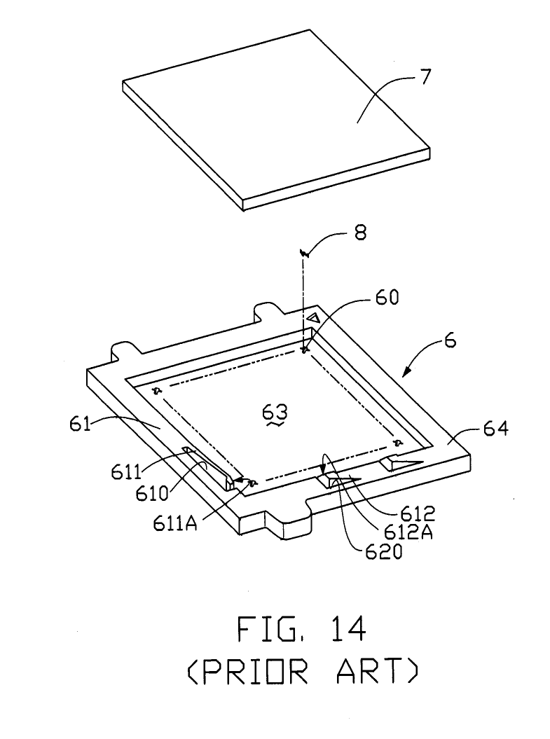

FIG. 13 shows the CPU 5 attached on the connector assembly, and being resiliently secured in the recess 21′ of the connector 2′ by the spring arms 241′. After the CPU 5′ is inserted in the recess 21′ of the connector 2′ with zero insertion force, the downward pushing force applied on the connector 2′ is released. The springs 324′ resiliently rebound to their normal positions, and the auxiliary tray 4 moves back up to its original position. During such movement, the retaining portions 242′ slidingly disengage from the guiding surfaces 322′ of the guiding blocks 321′. The spring arms 241′ thus resiliently rebound away from the corresponding sidewalls 24′ toward their normal positions. The retaining surfaces 244′ of the spring arms 241′ resiliently engage with corresponding sides of the CPU 5, and thereby securely retain the CPU 5 in the recess 21′ of the connector 2′. The connector 2′ is then taken out of the positioning space 41 of the auxiliary tray 4, for further use such as mounting on the PCB.

The connector assembly 10 utilizes the auxiliary tray 4 and the springs 324′, so that the springs 324′ can resiliently push the connector 2′ upwardly. Therefore, the spring arms 241′ can automatically disengage from the guiding blocks 321′. This facilitates the process of attaching the CPU 5 to the connector 2′.

Furthermore, conductive terminals 23′ may protrude out beyond a bottom of a conductive region 22′ of the connector 2′. Nevertheless, in the alternative embodiment of the present invention, the connector 2′ is engaged in the “suspended” position in the positioning space 41 of the auxiliary tray 4. This prevents the terminals 23′ from contacting any part of the auxiliary tray 4 that lies below the positioning space 41, and thus protects the terminals 23′ from being accidentally damaged by the auxiliary tray 4.

While preferred embodiments in accordance with the present invention have been shown and described, equivalent modifications and changes known to persons skilled in the art according to the spirit of the present invention are considered within the scope of the present invention as defined in the appended claims.

1. An electrical connector assembly for electrically connecting an electronic package with a circuit substrate, the electrical connector assembly comprising:
an electrical connector with a plurality of conductive terminals received in a conductive region thereof and comprising a plurality of raised sidewalls, at least a pair of spring arms formed in two adjacent sidewalls, and at least a pair of through slots defined throughout the conductive region, corresponding to the spring arms; and
a mounting base having at least a pair of guiding blocks provided thereon for mating with the spring arms of the connector.

2. The electrical connector assembly as claimed in claim 1, wherein the mounting base comprises a pair of opposite raised “U”-shape sidewalls, and defines a pair of cutouts between opposing ends of the sidewalls.

3. The electrical connector assembly as claimed in claim 2, wherein one guiding block is provided near one of the cutouts, and the other guiding block is provided near one of the sidewalls.

4. The electrical connector assembly as claimed in claim 1, wherein the raised sidewalls of the connector cooperatively define a recess, and the conductive region is defined on the connector under the recess.

5. The electrical connector assembly as claimed in claim 1, wherein each spring arm forms a retaining portion at a free distal end, the retaining portion comprising an inner vertical retaining surface, parallel to the corresponding sidewall, and a slantwise acting surface, below and adjoining the retaining surface.

6. The electrical connector assembly as claimed in claim 5, wherein each guiding block passes through a corresponding through slot of the connector and comprises a slantwise guiding surface facing a periphery of the connector and engaging with the acting surface of a corresponding spring arm.

7. The electrical connector assembly as claimed in claim 6, further comprising an auxiliary interbase attached with the mounting base.

8. The electrical connector assembly as claimed in claim 7, wherein the auxiliary interbase defines a pair of through acting slots, corresponding to the guiding blocks of the mounting base.

9. The electrical connector assembly as claimed in claim 8, wherein the auxiliary interbase defines a plurality of retaining holes in a bottom thereof.

10. The electrical connector assembly as claimed in claim 9, wherein the mounting base further defines a plurality of receiving holes, corresponding to the retaining holes of the auxiliary interbase.

11. The electrical connector assembly as claimed in claim 10, wherein each receiving hole receives an elastic member therein, and a top end of the elastic member is received in a corresponding retaining hole.

12. The electrical connector assembly as claimed in claim 11, wherein each elastic member is a coil spring.

13. A mounting system for use with an electrical connector to facilitate attaching of an electronic package on the connector, the mounting system comprising:
a mounting base comprising at least a pair of guiding blocks;
wherein each guiding block comprises a slantwise guiding surface facing a periphery of the connector.

14. The mounting system as claimed in claim 13, wherein the mounting base further comprises a pair of opposite raised “U”-shape sidewalls, and defines a pair of cutouts between opposing ends of the sidewalls.

15. The mounting system as claimed in claim 14, wherein one guiding block is provided near one of the cutouts, and the other guiding block is provided near one of the sidewalls.

16. The mounting system as claimed in claim 15, further comprising an auxiliary base attached with the mounting base.

17. The mounting system as claimed in claim 16, wherein the auxiliary base comprises a pair of positioning arms received in the cutouts of the mounting base, and defines a pair of through acting slots corresponding to the guiding blocks of the mounting base.

18. The mounting system as claimed in claim 17, wherein the auxiliary base further defines a plurality of retaining holes in a bottom thereof, and the mounting base further defines a plurality of receiving holes corresponding to the retaining holes of the auxiliary base.

19. An electrical assembly comprising:
an electrical connector including an insulative housing with a plurality of conductive terminals disposed therein, said housing defining an top face above which said terminals extend upwardly;
at least one spring arm located adjacent to said top face;
an electronic package seated upon the top face and restrained by a force derived from said spring arm; and
a mounting base detachably mounted under said housing under a condition that when said mounting base is substantially assembled with said connector, said spring arm is automatically forced, by said mounting base, to be deflected for removing said force from the electronic package so as to allow said electronic package to be installed or uninstalled relative to the housing in a zero force manner.

20. The assembly as claimed in claim 19, wherein said mounting base and said housing are assembled to each other in a vertical direction while said spring arm is deflected outwardly accordingly in a lateral direction perpendicular to said vertical direction.
